(19) United States
(12) Patent Application Publication
(10) Pub. No.: US 2026/0225820 A1
(43) Pub. Date: Aug. 6, 2026

(54) DUAL SIDED IMPELLER FOR PARTICLE SPREADER

(71) Applicant: Earthway Products, Inc., Bristol, IN (US)

(72) Inventors: Maxwell Imler, Elkhart, IN (US); Levi Siewert, Elkhart, IN (US); Kevin Fulmer, Middlebury, IN (US); Eric Seager, Jones, MI (US); Chris Wiessner, Scotts, MI (US); John Marshall, Granger, IN (US)

(21) Appl. No.: 19/046,751

(22) Filed: Feb. 6, 2025

(51) Int. Cl. B65G 31/04; A01C 17/00; B65G 47/18; E01H 10/00

(52) U.S. Cl. CPC B65G 31/04; A01C 17/001; A01C 17/005; B65G 47/18; B65G 2812/15; E01H 10/007

(57) ABSTRACT

A spreader for dispersing particulate material onto a ground surface, the spreader broadly comprising a frame, a hopper, wheels, an impeller shaft, and an impeller. The hopper includes an opening to allow the particulate material to pass therethrough. The wheels are rotatable relative to the frame. The impeller shaft is rotatable relative to the hopper. The impeller is coupled to the impeller shaft and rotatable therewith. The impeller has opposing first and second sides and includes a plate with opposing first and second surfaces, a first set of vanes, and a second set of vanes. The impeller is shiftable between a first configuration in which the first side faces a first direction and the second side faces a second direction and a second configuration in which the first side faces the second direction and the second side faces the first direction.

### TECHNICAL FIELD

Embodiments of the present invention relate to systems and methods for spreading particulate material.

### BACKGROUND OF THE INVENTION

Broadcast spreaders are used to spread or otherwise distribute particulate material or granules such as fertilizer, grass seed, salt, sand, ice melt, and the like onto surfaces such as lawns, golf courses, turf, sidewalks, parking lots. A key component of spreaders is a rotating impeller which flings particulate material over a dispersion pattern. Impellers wear out over time and must be replaced. This results in significant downtime, particularly since replacement impellers are often not kept on-hand. Furthermore, worn-out impellers, though functional, may effect degraded dispersion patterns. Due to the inability to immediately replace an impeller (or due to being unaware of the extent of wear on an impeller), an operator may continue using a worn-out impeller with a degraded dispersion pattern.

### BRIEF SUMMARY OF THE INVENTION

The instant invention is generally directed to walk-behind spreaders and powered spreaders that overcome the deficiencies of the spreaders discussed above.

An embodiment of the invention is a spreader broadly comprising a frame, a hopper connected to the frame and including an opening configured to allow particulate material to pass therethrough, a number of wheels rotatable relative to the frame, wheels rotatably connected to the frame and configured to roll along the ground surface, an impeller shaft rotatable relative to the hopper, and an impeller coupled to the impeller shaft and rotatable therewith. The impeller has opposing first and second sides and include a plate with opposing first and second surfaces, a first set of vanes extending from the first surface of the plate, and a second set of vanes extending from the second surface of the plate. The impeller is shiftable between a first configuration in which the first side faces a first direction and the second side faces a second direction and a second configuration in which the first side faces the second direction and the second side faces the first direction.

Another embodiment of the invention is a powered spreader broadly comprising a frame, a support for supporting an operator, a number of inputs configured to be manipulated by the operator for controlling the spreader, a hopper connected to the frame and including an opening configured to allow particulate material to pass therethrough, a number of wheels rotatable relative to the frame, a motor mounted to the frame and configured to drive at least one of the wheels according to manipulations of at least one of the inputs, an impeller shaft rotatable relative to the hopper, and an impeller coupled to the impeller shaft and rotatable therewith. The impeller has opposing first and second sides and include a plate with opposing first and second surfaces, a first set of vanes extending from the first surface of the plate, and a second set of vanes extending from the second surface of the plate. The impeller is shiftable between a first configuration in which the first side faces a first direction and the second side faces a second direction and a second configuration in which the first side faces the second direction and the second side faces the first direction.

Yet another embodiment of the invention is a method of operating a spreader. The method comprises steps of propelling the spreader across a ground surface and dispensing particulate material from a hopper of the spreader to an impeller having opposing first and second sides and including a plate with opposing first and second surfaces, a first set of vanes extending from the first surface and a second set of vanes extending from the second surface. The method further comprises a step of rotating the impeller in a first configuration in which the first side faces a first direction and the second side faces a second direction such that the particulate material impacts the first surface and the first set of vanes disperse the particulate material onto the ground surface. The method further comprises a step of shifting the impeller to a second configuration in which the first side faces the second direction and the second side faces the first direction. The method further comprises a step of rotating the impeller in the second configuration such that the particulate material impacts the second surface and the second plurality of vanes disperse the particulate material onto the ground surface.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE SEVERAL VIEWS OF THE DRAWINGS

The present invention is described in detail below with reference to the attached drawing figures, wherein:

FIG. 1 is a top perspective view of a spreader constructed in accordance with an embodiment of the invention;

FIG. 2 is a bottom perspective view of the spreader of FIG. 1;

FIG. 3 is a rear bottom perspective view of the spreader of FIG. 1;

FIG. 4 is a top perspective view of an impeller of the spreader of FIG. 1;

FIG. 5 is a bottom perspective view of the impeller of FIG. 4;

FIG. 6 is a top plan view of the impeller of FIG. 4;

FIG. 7 is a side elevation view of the impeller of FIG. 4;

FIG. 8 is a side elevation view of the impeller of FIG. 4;

FIG. 9 is a flow diagram of certain method steps of operating a spreader in accordance with another embodiment of the invention; and

FIG. 10 is a top perspective view of a spreader constructed in accordance with another embodiment of the invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the present invention references various embodiments. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

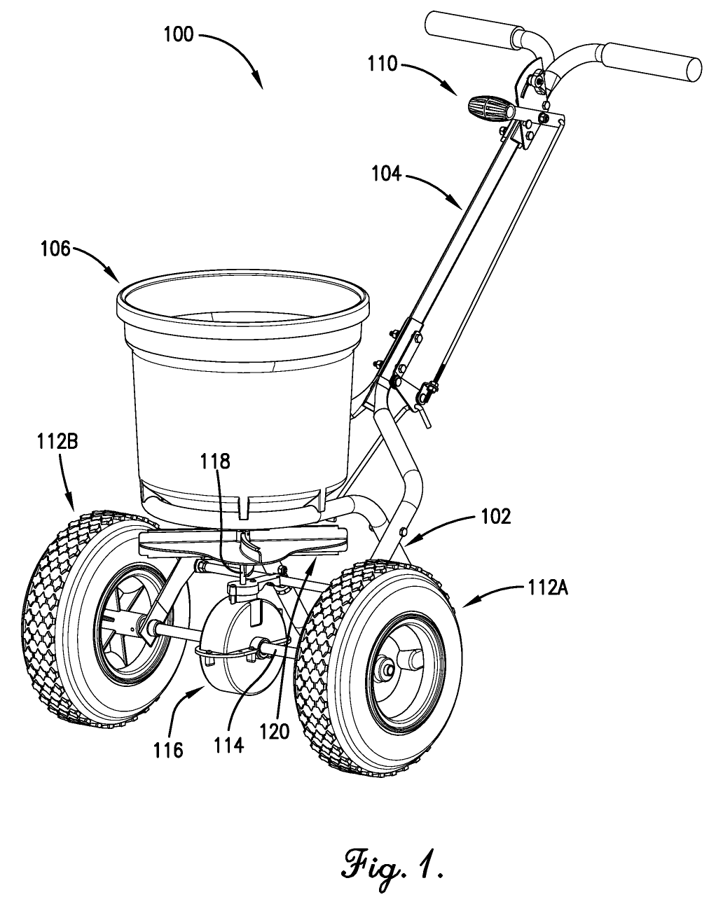

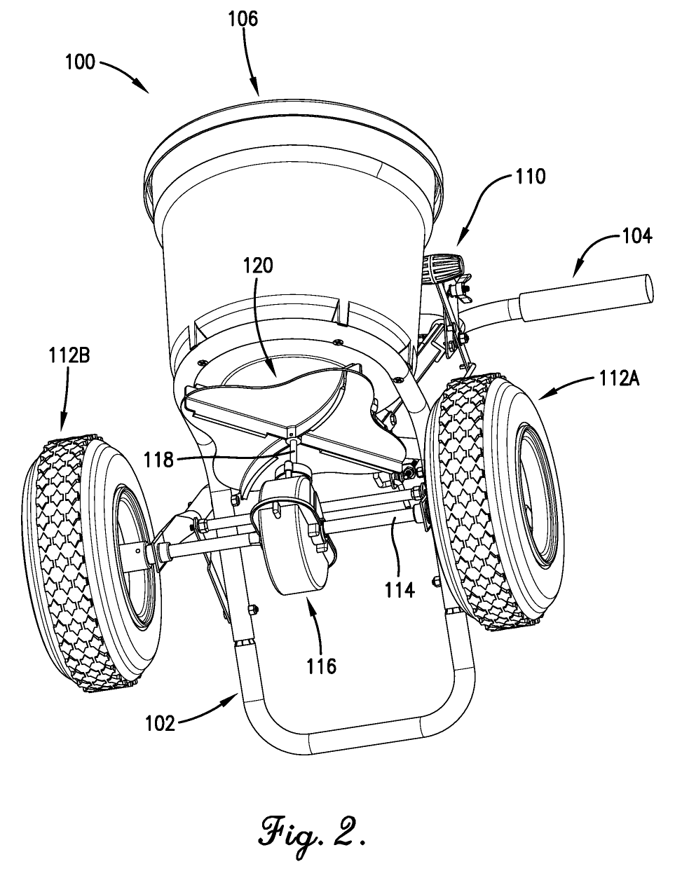

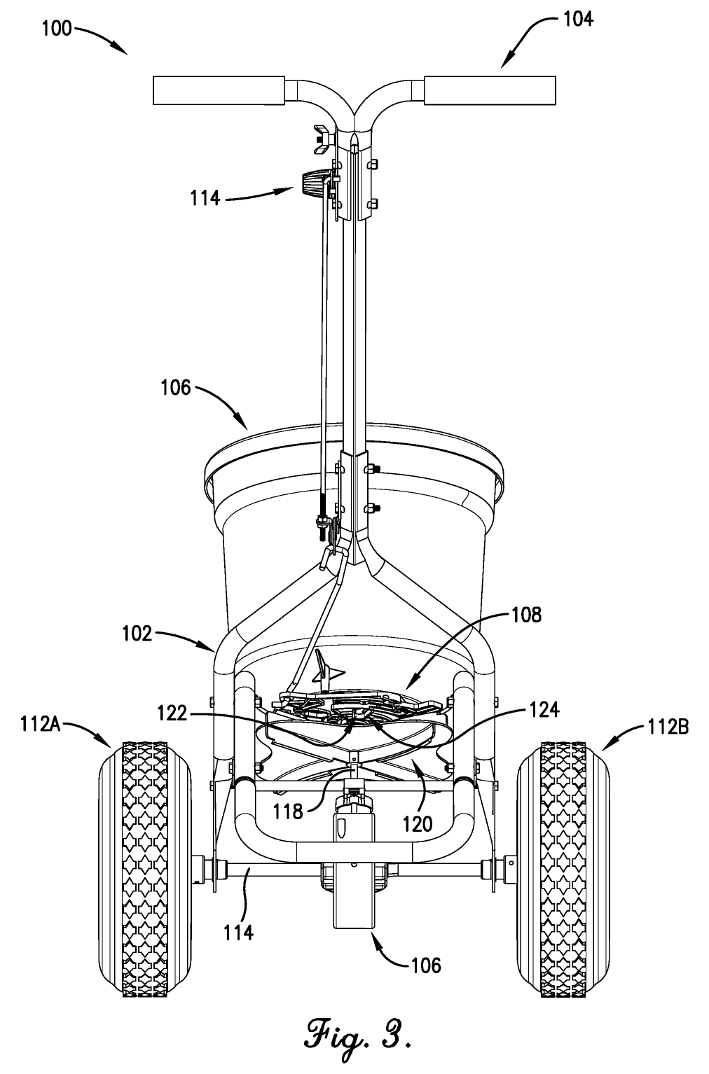

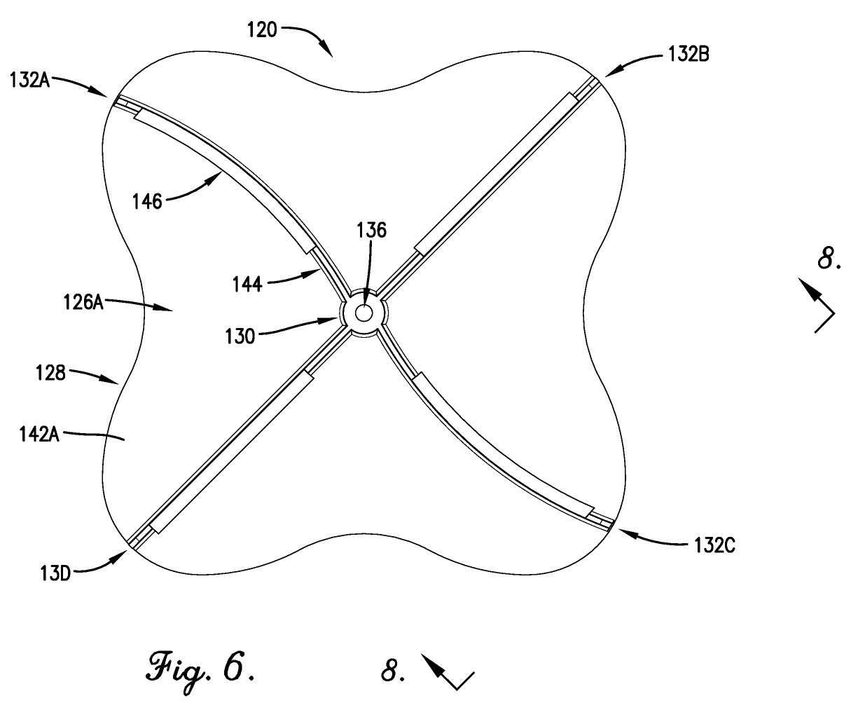

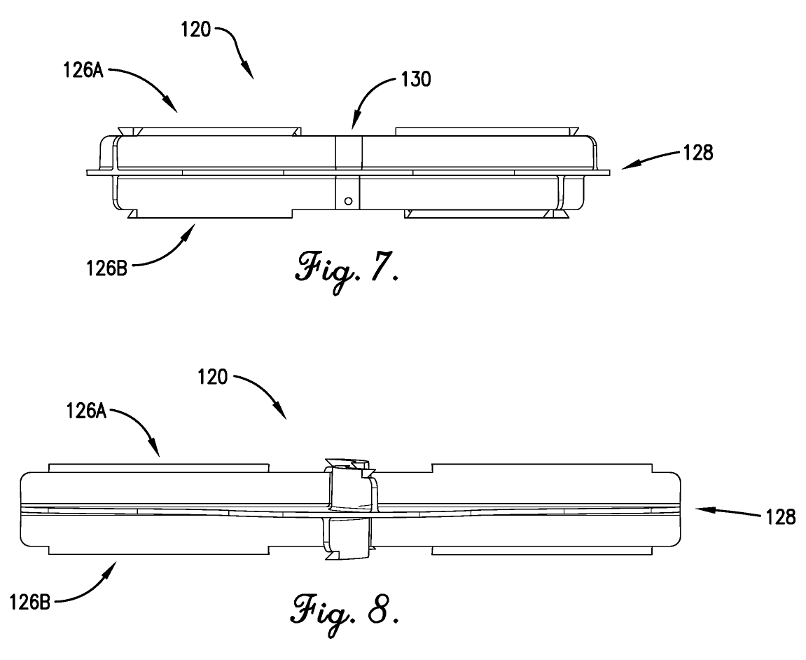

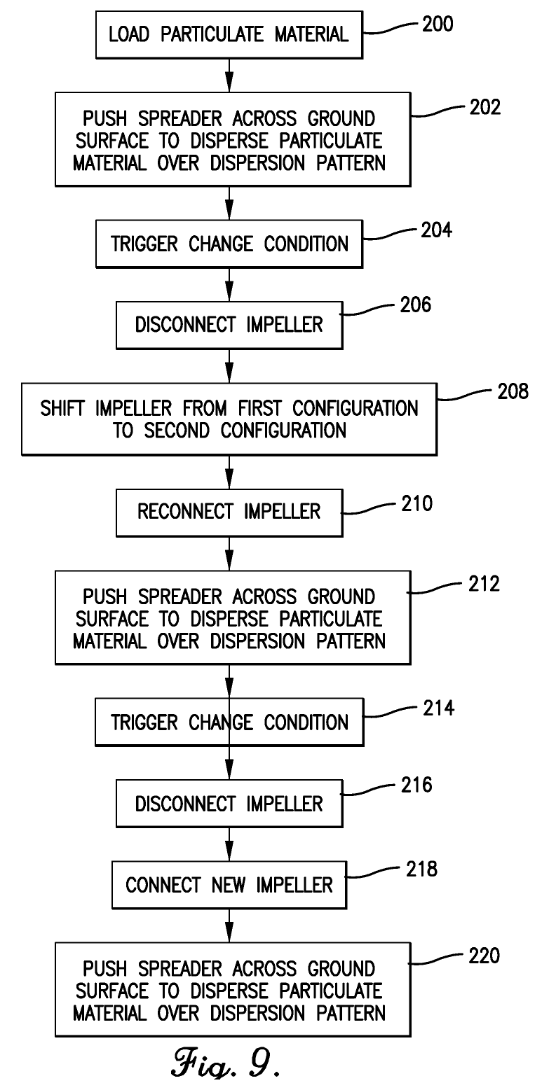

Turning to FIGS. 1-8, a spreader 100 constructed in accordance with an embodiment of the invention is illustrated. The spreader broadly comprises a frame 102, a handle 104, a hopper 106, a shut-off adjustment plate 108, an input 110, left and right wheels 112A,B, an axle 114, a drive train 116, an impeller shaft 118, and an impeller 120.

The frame 102 supports the hopper 106 and may include tubular members connected together. Some of the tubular members may have radiused bends for a strengthened and more ergonomic structure. The frame 102 may include a stand for supporting the spreader 100 with the left and right wheels 112A,B when the spreader 100 is not in use.

The handle 104 which may be part of the frame 102, may extend upward and rearward from below the hopper 106. The handle 104 allows an operator to push and guide the spreader 100 across the ground surface.

The hopper 106 may be an open-topped container for holding particulate material. The hopper 106 may include one or a plurality of openings 122 configured to permit particulate material to dispense from the hopper 106.

The shut-off adjustment plate 108 may be positioned between the hopper 106 and the impeller 120 and may be configured to pivot, rotate, or shift within a range of positions. The shut-off adjustment plate 108 may include one or a plurality of exit openings 124 configured to be in a range of alignment (from complete alignment to completely offset) with the openings 122 of the hopper 106 depending on the current positions of the shut-off adjustment plate 108. The shut-off adjustment plate 108 may be shiftable between the positions via the input 110.

The input 110 may be mounted near the handle 104 and connected to the shut-off adjustment plate 108 for shifting the shut-off adjustment plate 108 between positions. The input 110 may be a lever, a knob, a slider, a crank, or any other suitable control and may be linked to the shut-off adjustment plate 108 via a control rod, a cable, or the like.

The left and right wheels 112A,B may be rotatably mounted to the frame 102 and laterally spaced apart from each other on opposing ends of the axle 114. The left and right wheels 112A,B may be fitted with tires for contacting the ground surface. In an alternative embodiment, a single wheel may be located approximately laterally midway on the frame 102, in which case the frame 102 may be balanced on the single wheel during use.

The axle 114 may extend between the left and right wheels 112A,B and may be configured to rotate therewith. The axle 114 may extend through the drive train 116 or may be divided into left and right portions with the drive train 116 acting as a differential.

The drive train 116 may drivably connect the impeller shaft 118 to the axle 114 for transferring rotational force of the left or right wheels 112A,B to the impeller 120. The drive train 116 may be a gearbox, hydraulics, or the like. Alternatively, the impeller 120 may be driven independently from the left and right wheels 112A,B, in which case the drive train 116 may be omitted.

The impeller shaft 118 may extend upward from the drive train 116 to the impeller 120 and may be configured to rotate the impeller 120 due to rotation of at least one of the left and right wheels 112A,B. Alternatively, the impeller shaft 118 may be independently driven via an impeller motor.

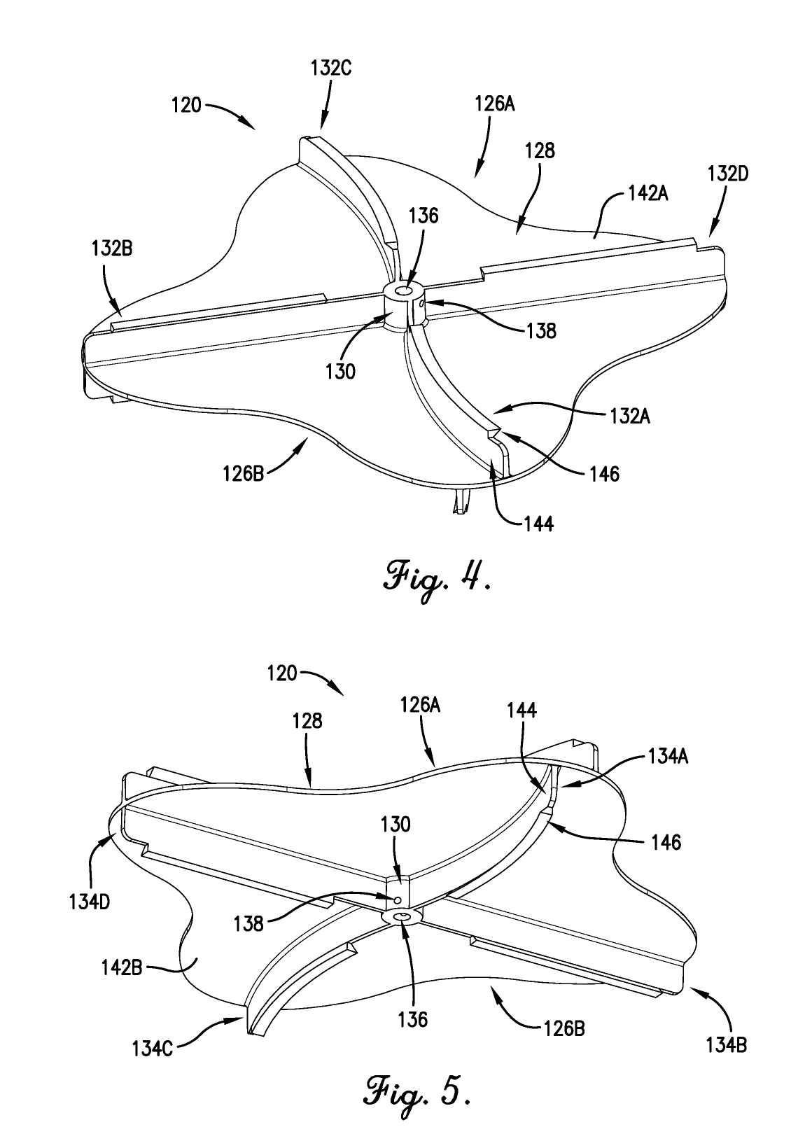

The impeller 120 may be removably connected to the impeller shaft 118 under the hopper 106 for dispersing particulate material in a dispersion pattern. As best seen in FIGS. 4-8, the impeller 120 may have opposing first and second sides 126A,B and may include a plate 128, a central shaft 130, a first plurality of vanes 132A-D on the first side 126A, and a second plurality of vanes 134A-D on the second side 126B. As described in more detail below, the impeller 120 may be disconnected from the impeller shaft 118 and turned over from a first configuration to a second configuration and reconnected to the impeller shaft 118. The first side 126A may be configured to face a first direction (e.g., toward the opening 122 of the hopper 106) and the second side 126B may be configured to face a second direction (e.g., away from the opening 122 of the hopper 106) when the impeller 120 is in the first configuration. The first side 126A may be configured to face the second direction and the second side 126B may be configured to face the first direction when the impeller 120 is in the second configuration. The impeller 120 may be formed of plastic (e.g., molded plastic, single mold plastic, injection molded plastic, or more specifically in one embodiment 11120 Polypropylene), metal, wood, or any other suitable material and may include a protective coating such as paint or the like.

The plate 128 may be oriented substantially horizontally (with the impeller 120 in the first or second configuration) when the impeller 120 is connected to the impeller shaft 118 and may include opposing first and second surfaces 142A,B. The first surface 142A may be configured to be impacted by particulate material falling from the hopper 106 when the impeller in the first configuration and the second surface 142B may be configured to be impacted by particulate material falling from the hopper 106 when the impeller 120 is in the second configuration.

The central shaft 130 may extend substantially perpendicular to the plate 128 and may include a central opening 136 therethrough and a set screw aperture 138 intersecting the central opening 136. The central opening 136 may be configured to receive the impeller shaft 118 therethrough. The set screw aperture 138 may be threaded and configured to receive a set screw therein for securing the impeller 120 on the impeller shaft 118. Alternatively, the impeller 120 may be secured to the impeller shaft 118 via friction fit, interlocking or alignment geometry, or other suitable features.

The first plurality of vanes 132A-D may extend from the first surface 142A and may include any number of vanes such as between two and six vanes. In one embodiment, the first plurality of vanes 132A-D includes four vanes. The first plurality of vanes 132A-D may include different shapes such as curved, segmented (segments connected at discrete angles), and linear. Each of the first plurality of vanes 132A-D may include a primary section 144 and a lip 146 on an end of the primary section 144 opposite the plate 128. The lip 146 may have a longitudinal length shorter than a longitudinal length of the primary section 144. The lip 146 may also have a thickness greater than a thickness of the primary section 144. At least one of the primary section 144 and lip 146 may be at least partially curved or angled (i.e., not perpendicular) extending from the plate 128. The lip 146 and the curvature/angled shape extending from the plate 128 may help keep particulate material in engagement with the impeller 120. In one embodiment, two opposing vanes 132A,C are linear and another two opposing vanes 132B,D are curved longitudinally (from a center of the impeller 120 outward). Such curvature may help disperse particulate material farther away while linear vanes may help disperse particulate material closer.

The second plurality of vanes 134A-D may be substantially similar to the first plurality of vanes 132A-D except the second plurality of vanes 134A-D extend from the second surface 142B. Alternatively, the second plurality of vanes 134A-D may have different shapes than shapes of the first plurality of vanes 132A-D. For example, the first plurality of vanes 132A-D may all be curved while the second plurality of vanes 134A-D may all be linear. In this way, the first plurality of vanes 132A-D may be more suitable for dispersing a first type of particulate material while the second plurality of vanes 134A-D may be more suitable for dispersing a second type of particulate material. This may be particularly useful for dispersing seeds or fertilizer in the spring or summer and dispersing salt, ice melt, or other treatment in the autumn or winter.

The features of the impeller 120 shown in FIGS. 1-8 are shaped, oriented, or arranged for counterclockwise rotation (from a plan view) when the impeller 120 is in either configuration. These features may instead be shaped, oriented, or arranged for clockwise rotation when the impeller 120 is in either configuration. As yet another alternative, features on one side of the impeller 120 may be shaped, oriented, or arranged for counterclockwise rotation when the impeller 120 is in one configuration and clockwise rotation when the impeller 120 is in the other configuration. Furthermore, the features may be shaped, oriented, or arranged to be substantially equally effective in either counterclockwise rotation or clockwise rotation. In addition, the features may be shaped, oriented, or arranged to effect one spread pattern in counterclockwise rotation and a different spread pattern in clockwise rotation.

Turning to FIG. 9, use of the spreader 100 will now be described in more detail. First, particulate material may be loaded into the hopper 106, as shown in block 200. The spreader 100 may then be pushed via the handle 104 to traverse a ground surface, as shown in block 202. Rotation of the wheels 112A,B over the ground surface cause the impeller 120 to rotate. Meanwhile, particulate material will fall through the opening(s) 122 of the hopper 106 and the exit openings 124 of the shut-off adjustment plate 108 and impact the first surface 142A of the plate 128 of the impeller 120 due to the impeller 120 being in the first configuration. Rotation of the impeller 120 will cause the first plurality of vanes 132A-D to fling the particulate material outward in a dispersion pattern on the ground surface. In one embodiment, vanes 132A,C fling particulate material to a first portion of the dispersion pattern and vanes 132B,D fling particulate material to a second portion of the dispersion pattern due to their differing shapes.

Dispersion of the particulate material may cause wear on the first surface 142A of the plate 128 and the first plurality of vanes 132A-D. This may undesirably alter the dispersion pattern, a dispersion rate, particle distribution, or other performance of the spreader 100. For example, wear may cause the dispersion pattern to shrink, expand, or shift. The first surface 142A of the plate 128 or the first plurality of vanes 132A-D may present a visual indication that the wear is sufficient to warrant shifting the impeller 120 to the second configuration. The visual indication may be a color change due to removal of a surface coating or surface layer, a smoothening or roughening of surfaces of the vanes 132A-D or of the first surface 142A, erosion or deformation of the vanes 132A-D themselves (which may include a surface coating or surface layer), or any other suitable visual queue. Erosion may be approximately 1 percent, approximately 10 percent, greater than 10 percent, or any other suitable percentage loss of material of a thickness of one of the vanes 132A-D.

Upon observation of the visual indication or alteration of the dispersion pattern, after an amount of time, after an amount of material has been dispersed, or upon any other suitable change condition being triggered (block 204), it may be desirable to utilize the second side 126B of the impeller 120. To do so, the impeller 120 may be disconnected from the impeller shaft 118, as shown in block 206. To that end, the set screw may be loosened in the set screw aperture 138 and the impeller 120 may be slid off the impeller shaft 118. The impeller 120 may then be shifted from the first configuration to the second configuration, as shown in block 208. The impeller 120 may then be reconnected to the impeller shaft 118 with the impeller 120 in the second configuration, as shown in block 210. To that end, the impeller 120 may be slid onto the impeller shaft 118 with the second side 126B facing the first direction and the set screw tightened in the set screw aperture 138. It should be noted the impeller 120 could remain attached to the impeller shaft 118 and the impeller shaft 118 (with impeller 120 attached) could be disconnected from the spreader 100, reconfigured, and reattached to the spreader 100. The spreader 100 may then be pushed to continue dispersing particulate material to the ground surface, as shown in block 212.

As before, dispersion of the particulate material may cause wear on the second surface 142B of the plate 128 and the second plurality of vanes 134A-D, which may undesirably alter the dispersion pattern, a dispersion rate, particle distribution, or other performance of the spreader 100. For example, wear may cause the dispersion pattern to shrink, expand, or shift. The second surface 142B of the plate 128 or the second plurality of vanes 134A-D may present a visual indication that the wear is sufficient to warrant replacing the impeller 120 with another impeller. The visual indication may be a color change due to removal of a surface coating or surface layer, a smoothening or roughening of surfaces of the vanes 132A-D or of the second surface 142B, erosion or deformation of the vanes 132A-D themselves (which may include a surface coating or surface layer), or any other suitable visual queue. Erosion may be approximately 1 percent, approximately 10 percent, greater than 10 percent, or any other suitable percentage loss of material of a thickness of one of the vanes 134A-D.

Upon observation of the visual indication or alteration of the dispersion pattern, after an amount of time, after an amount of material has been dispersed, or upon any other suitable change condition being triggered (block 214), and with both sides 126A,B having been worn, it may be desirable to utilize a new impeller. To do so, the impeller 120 may be disconnected from the impeller shaft 118, as shown in block 216. A new impeller may then be connected to the impeller shaft 118, as shown in block 218. The spreader 100 may then be pushed to continue dispersing particulate material to the ground surface, as shown in block 220.

In another embodiment, as described above, the impeller 120 may be used in the first configuration when dispersing a first type of particulate material, such as a seed or fertilizer, and the second configuration when dispersing a second type of particulate material, such as salt, ice melt, or other treatment. For example, the impeller 120 may be switched between first and second configurations at the start of a new season.

The above-described spreader 100 and impeller 120 provide several advantages. For example, the two sides 126A,B provide approximately twice the lifespan compared to a conventional spreader. This is true whether the impeller 120 is switched between configurations due to wear or due to a change in type of particulate material being dispersed. The impeller 120 may also present a visual indicator alerting the operator that the impeller 120 should be turned over or replaced. The vanes 132A-D can effectively spread different types of particulate material or effect enhanced dispersion patterns.

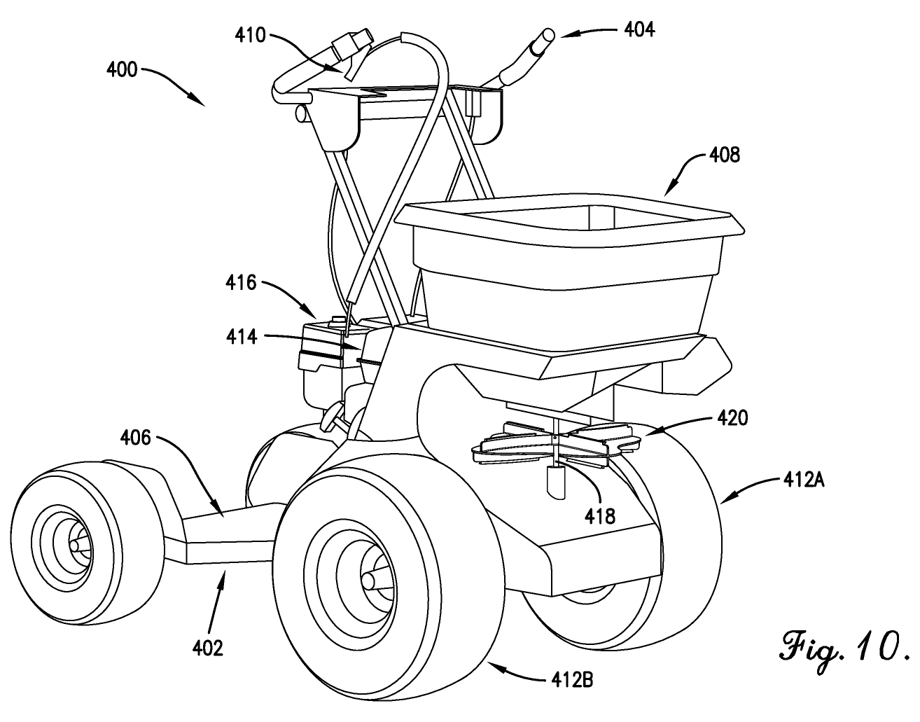

Turning to FIG. 10, a powered spreader 400 constructed in accordance with another embodiment will now be described. The spreader broadly comprises a frame 402, a handle 404, a platform 406, a hopper 408, a platform 406, a shut-off adjustment plate, an input 410, left and right wheels 412A,B, an axle, a drive train, a motor 414, an energy supply 416, an impeller shaft 418, and an impeller 420.

The frame 402 supports the hopper 408 and may include tubular members connected together. Some of the tubular members may have radiused bends for a strengthened and more ergonomic structure. The frame 402 may include a stand for supporting the spreader 400 with the left and right wheels 412A,BA,B when the spreader 400 is not in use.

The handle 404 which may be part of the frame 402, extends upward and rearward from below the hopper 408 or from the frame 402. The handle 404 may be gripped by the operator for support and for manipulating the input 410.

The platform 406 may support the operator during use of the spreader 400 in a stand-on mode. The spreader 400 may also or alternatively include a chair for use in a sit-down mode.

The hopper 408 may be an open-topped container for holding particulate material. The hopper 408 may include one or more openings configured to permit particulate material to dispense from the hopper 408.

The shut-off adjustment plate may be positioned between the hopper 408 and the impeller 420 and may be configured to pivot, rotate, or shift within a range of positions. The shut-off adjustment plate may include a plurality of exit openings configured to be in a range of alignment (from complete alignment to completely offset) with the openings of the hopper 408 depending on the current positions of the shut-off adjustment plate. The shut-off adjustment plate may be shiftable between the positions via the input 410.

The input 410 may be mounted near the handle 404 and connected to the shut-off adjustment plate for shifting the shut-off adjustment plate between positions. The input 410 may be a lever, a knob, a slider, a crank, or any other suitable control and may be linked to the shut-off adjustment plate via a control rod, a cable, or the like. The spreader 400 may include additional inputs such as a throttle lever for controlling the motor, and hence a traversing speed of the spreader 400. Furthermore, the spreader 400 may include driving inputs such as a steering wheel, differential brake levers, or the like for steering the spreader 400.

The left and right wheels 412A,B may be rotatably mounted to the frame 402 and laterally spaced apart from each other on opposing ends of the axle. The left and right wheels 412A,B may be fitted with tires for contacting the ground surface. At least one of the left and right wheels 412A,B may be drivably connected to the motor 414 via a drive train (e.g., gearbox, hydraulics, or the like) for propelling the spreader 400.

The axle may extend between the left and right wheels 412A,B and may be configured to rotate therewith. The axle may extend through the drive train or may be divided into left and right portions with the drive train acting as a differential.

The motor 414 may be drivably connected to at least one of the left and right wheels 412A,B via the axle and a drive train. The motor 414 may be an electric motor, a gasoline or diesel engine, or the like.

The energy supply 416 may provide energy to the motor 414. The energy supply 416 may be a battery in the case of an electric motor and a gasoline or diesel fuel tank in the case of an engine.

The drive train may drivably connect the impeller shaft 418 to the axle for transferring rotational force of the left or right wheels 412A,B to the impeller 420. The drive train may be a gearbox, hydraulics, or the like. Alternatively, the impeller 420 may be driven independently from the left and right wheels 412A,B, in which case the drive train may be omitted.

The impeller shaft 418 may extend upward from the drive train to the impeller 420 and may be configured to rotate the impeller 420 due to rotation of at least one of the left and right wheels 412A,B. Alternatively, the impeller shaft 418 may be independently driven via an impeller motor.

The impeller 420 may be substantially similar to the impeller 120 described above and thus will not be described in further detail. The impeller 420 may be particularly useful for the powered spreader 400 because the powered spreader 400 may be operated for long periods of time, in harsher conditions, or across a wider range of applications. A doubled impeller lifespan becomes significant in such cases.

### ADDITIONAL CONSIDERATIONS

In this description, references to "one embodiment," "an embodiment," or "embodiments" mean that the feature or features being referred to are included in at least one embodiment of the technology. Separate references to "one embodiment," "an embodiment," or "embodiments" in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as the processing system and control systems, may be implemented as special purpose or as general purpose devices. For example, the processing system may comprise dedicated circuitry or logic that is permanently configured, such as an application-specific integrated circuit (ASIC), or indefinitely configured, such as an FPGA, to perform certain operations. The processing system may also comprise programmable logic or circuitry (e.g., as encompassed within a general-purpose processor or other programmable processor) that is temporarily configured by software to perform certain operations. It will be appreciated that the decision to implement the processing system as special purpose, in dedicated and permanently configured circuitry, or as general purpose (e.g., configured by software) may be driven by cost and time considerations.

Accordingly, the terms "processing system" or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing system is temporarily configured (e.g., programmed), each of the processing elements need not be configured or instantiated at any one instance in time. For example, where the processing system comprises a general-purpose processor configured using software, the general-purpose processor may be configured as respective different processing elements at different times. Software may accordingly configure the processing system to constitute a hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, later, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as "processing," "computing," "calculating," "determining," "presenting," "displaying," or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms "comprises," "comprising," "includes," "including," "has," "having" or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as "means for" or "step for" language being explicitly recited in the claim(s).

Although the invention has been described with reference to the embodiments illustrated in the attached drawing figures, it is noted that equivalents may be employed and substitutions made herein without departing from the scope of the invention as recited in the claims. For example, the principles of the present invention are not limited to the illustrated central pivot irrigation systems but may be implemented in any type of irrigation system including linear move irrigation systems.

Having thus described various embodiments of the invention, what is claimed as new and desired to be protected by Letters Patent includes the following:

What is claimed is:

1. A spreader for dispersing particulate material onto a ground surface, the spreader comprising:
a frame;
a hopper connected to the frame and including an opening configured to allow the particulate material to pass therethrough;
a plurality of wheels rotatable relative to the frame for traversing the ground surface;
an impeller shaft rotatable relative to the hopper;
an impeller coupled to the impeller shaft and rotatable therewith, the impeller having opposing first and second sides and including:
a plate including opposing first and second surfaces;
a first plurality of vanes extending from the first surface of the plate; and
a second plurality of vanes extending from the second surface of the plate,
wherein the impeller is shiftable between a first configuration in which the first side faces a first direction and the second side faces a second direction and a second configuration in which the first side faces the second direction and the second side faces the first direction.

2. The spreader of claim 1, wherein the first plurality of vanes and the second plurality of vanes each have a first shape for dispersing the particulate material over a first portion of a dispersion pattern and a second shape for dispersing the particulate material over a second portion of the dispersion pattern.

3. The spreader of claim 2, wherein the first shape is a curved shape and the second shape is linear.

4. The spreader of claim 1, wherein the particulate material separately includes a first type of particulate material and a second type of particulate material, and wherein the first plurality of vanes have a first shape for dispersing the first type of particulate material and the second plurality of vanes have a second shape for dispersing the second type of particulate material.

5. The spreader of claim 4, wherein the first shape is a curved shape and the second shape is linear.

6. The spreader of claim 1, wherein each vane of the first plurality of vanes and second plurality of vanes includes a primary section and a lip having a thickness greater than a thickness of the primary section.

7. The spreader of claim 1, wherein each vane of the first plurality of vanes and second plurality of vanes includes a primary section and a lip having a shorter longitudinal length than a longitudinal length of the primary section.

8. The spreader of claim 1, wherein the plate, the first plurality of vanes, and the second plurality of vanes are formed of a monolithic molded material.

9. The spreader of claim 1, wherein the first plurality of vanes is configured to present a visual indication that the impeller should be shifted from the first configuration to the second configuration.

10. The spreader of claim 1, wherein the first plurality of vanes is configured to disperse the particulate material over a dispersion pattern such that wear of the first plurality of vanes alters the dispersion pattern.

11. A powered spreader for dispersing particulate material onto a ground surface, the powered spreader comprising:
a frame;
a support for supporting an operator;
an input configured to be manipulated by the operator for controlling the spreader;
a hopper connected to the frame and including an opening configured to allow the particulate material to pass therethrough;
a plurality of wheels rotatable relative to the frame for traversing the ground surface;
a motor mounted to the frame and configured to drive at least one of the plurality of wheels;
an impeller shaft rotatable relative to the hopper;
an impeller coupled to the impeller shaft and rotatable therewith, the impeller having opposing first and second sides and including:
a plate including opposing first and second surfaces;
a first plurality of vanes extending from the first surface of the plate; and
a second plurality of vanes extending from the second surface of the plate,
wherein the impeller is shiftable between a first configuration in which the first side faces a first direction and the second side faces a second direction and a second configuration in which the first side faces the second direction and the second side faces the first direction.

12. The powered spreader of claim 11, wherein the first plurality of vanes and the second plurality of vanes each have a first shape for dispersing the particulate material over a first portion of a dispersion pattern and a second shape for dispersing the particulate material over a second portion of the dispersion pattern.

13. The powered spreader of claim 11, wherein the particulate material separately includes a first type of particulate material and a second type of particulate material, and wherein the first plurality of vanes have a first shape for dispersing the first type of particulate material and the second plurality of vanes have a second shape for dispersing the second type of particulate material.

14. The powered spreader of claim 11, wherein the first plurality of vanes is configured to present a visual indication that the impeller should be shifted from the first configuration to the second configuration.

15. The powered spreader of claim 11, wherein the first plurality of vanes is configured to disperse the particulate material over a dispersion pattern such that wear of the first plurality of vanes alters the dispersion pattern.

16. A method of operating a spreader, the method comprising steps of:
propelling the spreader across a ground surface;
dispensing particulate material from a hopper of the spreader to an impeller having opposing first and second sides and including:
a plate including opposing first and second surfaces;
a first plurality of vanes extending from the first surface of the plate; and
a second plurality of vanes extending from the second surface of the plate;
rotating the impeller in a first configuration in which the first side faces a first direction and the second side faces a second direction such that the particulate material impacts the first surface and the first plurality of vanes disperse the particulate material onto the ground surface;
shifting the impeller to a second configuration in which the first side faces the second direction and the second side faces the first direction; and
rotating the impeller in the second configuration such that the particulate material impacts the second surface and the second plurality of vanes disperse the particulate material onto the ground surface.

17. The method of claim 16, wherein the first plurality of vanes and the second plurality of vanes each have a first shape for dispersing the particulate material over a first portion of a dispersion pattern and a second shape for dispersing the particulate material over a second portion of the dispersion pattern.

18. The method of claim 16, further comprising a step of effecting wear of the first plurality of vanes so that the spreader dispenses the particulate material in an altered dispersion pattern.

19. The method of claim 16, further comprising a step of propelling the spreader via at least one of an electric motor and an internal combustion engine.

20. The method of claim 16, wherein the particulate material separately includes a first type of particulate material and a second type of particulate material, and wherein the step of rotating the impeller in the first configuration includes dispersing the first type of particulate material and the step of rotating the impeller in the second configuration includes dispersing the second type of particulate material.
